(19) United States
(12) Patent Application Publication
(10) Pub. No.: US 2017/0051546 A1
(43) Pub. Date: Feb. 23, 2017

(54) Pivot Pin with Installation Assistance Feature

(71) Applicant: Glen Dale Seekins, Lewiston, ID (US)

(72) Inventor: Glen Dale Seekins, Lewiston, ID (US)

(73) Assignee: Seekins Precision, LLC, Lewiston, ID (US)

(21) Appl. No.: 15/243,861

(22) Filed: Aug. 22, 2016

Related U.S. Application Data
(60) Provisional application No. 62/208,789, filed on Aug. 23, 2015.

(51) Int. Cl. E05D 5/12; F41A 3/66; F41A 11/00

(52) U.S. Cl. CPC E05D 5/128; F41A 11/00; F41A 3/66; E05D 2005/102

(57) ABSTRACT

Pivot pin with a hole permitting passage of a pivot pin detent spring and pivot pin detent to facilitate installation.

### CROSS-REFERENCE TO RELATED APPLICATIONS

This application claims priority to provisional application 62208789 filed on Aug. 23, 2015.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

Not Applicable

### STATEMENT REGARDING PRIOR DISCLOSURES BY AN INVENTOR OR JOINT INVENTOR

Not Applicable

### BACKGROUND OF THE INVENTION

The M16/AR15 firearm platform has existed for more than 55 years. It is a highly modular system permitting many accessories and components to be installed, removed, and exchanged with minimal effort.

Pivot Pin

A pivot pin is used to connect upper and lower receivers in M16/AR15 style firearms and is well known in the art. A pivot pin is generally cylindrical with an enlarged head on one end. Along a portion of the length is a detent groove with the groove deeper at both ends. At the end of the groove farther the enlarged head, a small disassembly hole passes through the diameter of the pin ending in the deeper portion of the detent groove. This hole has a diameter smaller than a pivot pin detent. The hole permits a small diameter instrument to be inserted through the pin and depress the pivot pin detent facilitating disassembly.

Pivot Pin Detent

A pivot pin detent is well known in the art. A pivot pin detent is a generally cylindrical pin with at least one generally conical frustum shaped end. It cooperatively interacts with the pivot pin by traveling laterally in the pivot pin detent groove to prevent the pivot pin from rotating or traveling in either direction beyond the end of the groove. The increased depth at the ends of the grove requires the application of force to depress the detent by lateral motion of the pivot pin against the angled end of the detent and allow the pin to slide.

Pivot Pin Spring

A pivot pin spring is well known in the art. A pivot pin string exerts pressure against a lower receiver on one end and a pivot pin detent on the other end. The spring maintains pressure on the pivot pin detent against the pivot pin.

Pivot Pin Installation Tool

Installing a pivot pin is among the more difficult tasks in assembling an M16/AR15 lower receiver. The pivot pin spring must be inserted into a guide hole in a lower receiver and a detent placed over the spring. Then the spring must be compressed beneath the detent and the pivot pin slid into position. In order to make the process easier, specialized tools have been created which are approximately the same diameter as the pin and which have a hole passing through the diameter of the tool. The hole is large enough for the spring and detent to be inserted through the hole. Pressure is then applied on the detent using an assembly pin compressing the spring. The tool is then rotated leaving the detent depressed. The pivot pin is then placed end-to-end with the tool which acts as a slave pin and the tool is pushed out using the pivot pin.

### BRIEF SUMMARY OF THE INVENTION

A pivot pin with an installation assistance hole permitting components to be passed through and tensioned.

### BRIEF DESCRIPTION OF THE SEVERAL VIEWS OF THE DRAWING

FIG. 1 shows the applicant's invention. The conventional retention groove and conventional detent recessions are shown on the top. The novel installation assistance feature is shown near the right end.

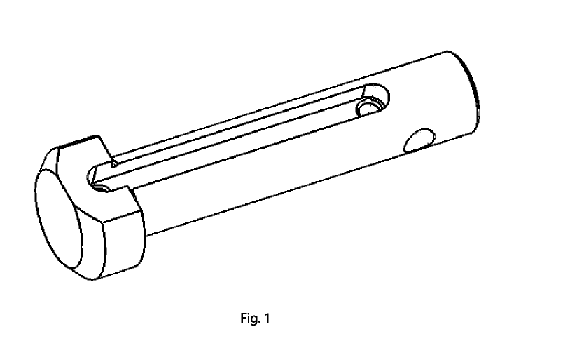

FIG. 2 shows the applicant's invention. The non-conventional installation feature is shown passing through the pin near the left end.

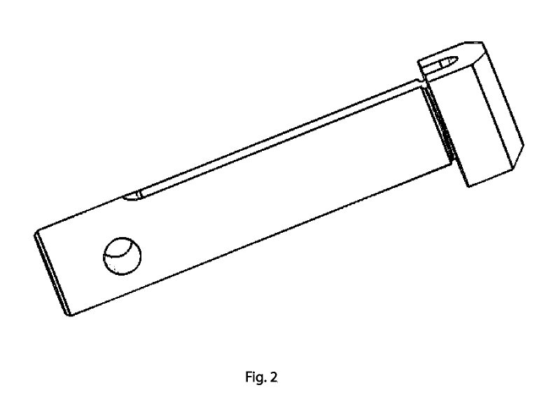

### DETAILED DESCRIPTION OF THE INVENTION

The applicant's invention is a modified pivot pin having a hole configured in the pivot pin passing through the diameter of the pin between the disassembly hole and the adjacent end. This hole has a sufficiently large diameter for a pivot pin spring and pivot pin detent to be inserted through the hole. This configuration permits the hole to be aligned with the pivot pin guide in the lower receiver and the pivot pin spring and pivot pin detent to be inserted through the pivot pin. A depression tool is then used to depress the pivot pin detent permitting the pivot pin to be rotated or slid until the detent can no longer pass through the installation assistance hole thus capturing the detent and spring. The depression tool can then be withdrawn from the installation assistance hole and the pivot pin can then be rotated and laterally slid until the detent is captured by the retention groove.

1. A pivot pin for attaching firearm receiver portions comprising: an installation assistance hole configured in the pivot pin passing through the diameter of the pin, between a disassembly hole and the end adjacent the disassembly hole, having a diameter sufficiently large to permit transverse passage of a pivot pin detent spring and pivot pin detent.

2. The pivot pin of claim 1 wherein the installation assistance hole is perpendicular to the disassembly hole.
